(19) United States
(12) Patent Application Publication
(10) Pub. No.: US 2007/0071590 A1
(43) Pub. Date: Mar. 29, 2007

(54) Spillbox system for a shipping container

(76) Inventor: Stephen D. Podd, Rouses Point, NY (US)

Correspondence Address: DORITY & MANNING, P.A., POST OFFICE BOX 1449, GREENVILLE, SC, 29602-1449, US

(21) Appl. No.: 11/231,399

(22) Filed: Sep. 21, 2005

(51) Int. Cl. B65F 9/00

(52) U.S. Cl. 414/809

(57) ABSTRACT

A payload system for a cargo carrier includes a spillbox having a collar, a tube and a valve. The collar seats about a manhole of a shipping container. The tube has a first end and a second end, the first end being connectable to a flexiliner installed in the shipping container. The second end is connectable to the valve for communicating a load of cargo through the manhole via the spillbox. The spillbox is unseated from about the manhole to remove the flexiliner through the manhole after the load of cargo is extracted from the flexiliner.

### FIELD OF THE INVENTION

This invention relates to a loading and unloading system for a shipping container.

### BACKGROUND OF THE INVENTION

Shipping containers can be used to carry a variety of liquids ranging from toxic chemicals to consumables such as wine and other beverages. When a shipping container is used to carry a chemical, for instance, from a loading point to a destination point, the shipping container must be cleaned thoroughly of chemical residue in order to reload the shipping container with another chemical. More often than not, the destination point may not have a cleaning station, so the shipping container must be shipped empty to a distant cleaning station to clean the chemical residue. This is inefficient and costly due to an empty transport or required repositioning of the shipping container. Even if the cleaning station is at the destination point, conventional cleaning of the cargo container is relatively expensive and inconvenient. Moreover, whether the shipping container is cleaned at the destination point or shipped to the distant cleaning station, the shipping container is unusable until cleaned and may be out of service for an undesirable period of time.

One attempt to avoid conventional cleaning of the shipping container uses a removable plastic carrier that lines an interior surface of the shipping container to carry the liquid chemical or the consumable liquid to the destination point. At the destination point, the liquid is discharged from the plastic carrier, which is removed from the shipping container and replaced with another plastic carrier. These removable plastic carriers suffer from various drawbacks. For instance, the removable plastic carrier uses a plastic discharge sleeve attached near a bottom portion of the plastic carrier. At the destination point, a valve assembly on a lower exterior part of the shipping container is at least partially disassembled or removed entirely to open an aperture in the shipping container in order to extract the discharge sleeve through aperture. Once the discharge sleeve has been extracted, the valve assembly is reassembled or reattached, which usually requires replacing numerous seals that are broken during the extraction process. This sleeve extraction process requires intensive labor and skill, takes an inordinate amount of time and can be costly due to seal replacements or other damage to the valve assembly, and the valve must be replaced or cleaned.

A liner system is needed in the shipping industry that can be readily installed in a shipping container, which will permit rapid loading and unloading of liquids without having to disconnect or adapt components of the shipping container to accommodate the liner system.

### BRIEF SUMMARY OF THE INVENTION

The present invention is directed in general to a drop-in, pull-out spillbox system for a cargo carrier that requires no preparation or modification of the cargo carrier. The spillbox system permits rapid loading and unloading of various liquids through a manhole of the cargo carrier. The spillbox system also prevents workers from contaminating liquid in the cargo carrier; protects the workers from falling through the manhole; and if there is an overflow, the spillbox system prevents spillage from entering the cargo carrier and contaminating the liquid in the cargo carrier. Other advantages of various embodiments of the invention will be apparent from the following description and the attached drawings, or can be learned through practice of the invention.

In one aspect of the invention, a method of using a payload system with a cargo carrier includes the steps of providing a flexiliner with a conduit attached thereto; installing the flexiliner through a manhole of a shipping container; providing a spillbox having a collar, a tube and a valve, the tube defining a first end and a second end; connecting the first end to the conduit, the second end being connected to the valve; and seating the collar about the manhole for communicating a load of cargo therethrough to prevent contamination of the cargo.

According to an aspect of the method, the flexiliner can be made of an elastomeric or thermoplastic material and can have a thickness of about 20 MIL to about 60 MIL.

According to a further aspect of the method, the flexiliner can be made with a reinforcement section having a thickness of about 40 MIL to about 80 MIL, the conduit being attached to the reinforcement section.

According to yet a further aspect of the method, the conduit includes a flange with a sleeve depending therefrom, the flange attached to the exterior surface, the sleeve having an inner surface defining an inner diameter and having a disconnect assembly, the first end having an outer diameter smaller than the inner diameter, and further comprising the steps of inserting the first end in the inner diameter and engaging the first end with the disconnect assembly.

According to another aspect of the method, the manhole defines an access port having a plurality of latches disposed thereabout and a manhole lid having a plurality of catches disposed thereabout, and further comprising the step of connecting each of the latches to respective ones of the catches to lock the spillbox under the manhole lid.

Also according to the method, the spillbox can be secured within the access port using a plurality of tie-downs.

Further according to the method, the valve defines a tube end, an orifice end and a lever, the tube connected to the tube end of the valve, and further comprising the steps of attaching a supply hose to the orifice end and activating the lever to open or close communication between the orifice end and the tube end to move the load of cargo from the supply hose through the orifice and tube ends into the flexiliner.

According to another aspect, the method can include the step of seating a lip disposed about a perimeter of the collar on a complementary lip defined about the manhole.

The method can further include the step of closing a liner valve attached to the conduit, the liner valve being configured to close the flexiliner during removal of the flexiliner from the manhole to prevent a residue of the cargo from spilling from the flexiliner

The method can also include the step of providing cartons for packaging the flexiliner and the spillbox as a kit. According to one aspect, the flexiliner can be vacuum packed for installation in a carton.

The method can further include the steps of unfolding the carton, the carton defining a cut-out therein, the cut-out complementary in size to the manhole, and positioning the cut-out over the manhole to protect the flexiliner from damage during installation through the cut-out into the manhole.

The method can also include the step of unfolding the flexiliner in the shipping container.

The method can further include the step of snap-fitting the first end of the tube to the sleeve of the flexiliner in the shipping container.

The method can also include the step of locking the first end of the tube to the sleeve of the flexiliner in the shipping container using a quick disconnect lever.

The method can include the step of unseating the spillbox from about the manhole after the load of cargo is extracted from the flexiliner.

The method can further include the step of removing the flexiliner through the manhole after the load of cargo is extracted from the flexiliner.

The method can also include the step of vacuuming the flexiliner to condense the flexiliner before extracting the flexiliner through the manhole.

The method can further include the step of discarding the flexiliner after removing the flexiliner through the manhole.

According to another embodiment of the inventive subject matter, a payload system for a cargo carrier is provided including a liner defining an exterior surface and an opposing interior surface and having a conduit attached to the exterior surface, the conduit defining an aperture therethrough in communication with the interior surface, the liner being configured for installation in a shipping container through a manhole of the shipping container; and a spillbox including a collar, a tube and a valve, the collar being configured to seat about the manhole, the tube defining a first end and a second end, the first end being connectable to the conduit, the second end being connectable to the valve for communicating a load of cargo through the manhole, the spillbox being further configured for unseating from about the manhole and the liner being further configured for removal through the manhole when the load of cargo is extracted from the liner.

The liner in this aspect of the invention can be an elastomeric liner. The liner can be made from a polyethylene material. The liner can have a thickness of about 20 MIL to about 40 MIL. More specifically, the liner may have a thickness of about 20 MIL and include a reinforcement section having a thickness of about 40 MIL to about 80 MIL, the conduit being attached to the reinforcement section.

According to this aspect of the invention, the conduit includes a flange with a sleeve depending therefrom, the flange attached to the exterior surface, the sleeve having an inner surface defining an inner diameter and having a disconnect assembly, the first end having an outer diameter smaller than the inner diameter, the disconnect assembly being configured to engage the first end when the outer diameter is disposed in the inner diameter.

Also in this aspect of the invention, the manhole includes an access port and a manhole lid, the access port being configured for human entry, the manhole lid being configured for opening and closing the access port. The access port can include a plurality of latches disposed thereabout and the manhole lid can define a plurality of catches disposed thereabout, each of the latches being configured to connect to respective ones of the catches to lock the spillbox under the manhole lid. A plurality of tie-downs can be provided to secure the spillbox within the access port.

Also in this aspect of the invention, the collar defines a recess therein and the valve includes an orifice end and a cap, the orifice end defining an orifice therethrough, the cap being configured to access the orifice, the cap when attached to the orifice end disposed in the recess under the manhole lid.

Further in this aspect of the invention, the valve also includes a tube end, an orifice end and a lever, the tube connected to the tube end of the valve, the orifice end connectable to a supply hose and the lever being configured to open and close communication between the orifice end and the tube end to move the load of cargo from the supply hose through the orifice end and the tube end into the liner.

Also in this aspect of the invention, the collar defines a perimeter and a lip disposed about the perimeter and the manhole defines a complementary lip for seating the lip of the collar.

Further in this aspect of the invention, a liner valve is attached to the conduit, the liner valve being configured for closure during removal of the liner from the manhole to prevent a residue of the cargo from spilling from the liner.

Also in this aspect of the invention, cartons can be provided for shipping the liner and the spillbox as a kit. The cartons are configured to be unfolded and defines a cut-out therein, the cut-out being complementary in size to the manhole, the carton being further configured to protect the liner from damage during installation through the cut-out into the manhole.

In another embodiment according to the invention, a payload system for a cargo carrier includes a flexiliner defining an exterior surface and an opposing interior surface, the flexiliner having a reinforcement panel formed on a portion of the exterior surface, the flexiliner being configured for installation through a manhole of a shipping container; a valve attached to the reinforcement panel, the valve defining an aperture therethrough in selectable communication with the interior surface; and an air vent disposed proximate the valve, the air vent defining an opening therethrough in selectable communication with the interior surface, the air vent being configured to inflate the flexiliner to dispose the valve and the air vent at the manhole for loading or unloading cargo.

The flexiliner can be made from a polyethylene material and have a thickness of about 20 MIL to about 40 MIL. The reinforcement section can have a thickness of about 40 MIL to about 80 MIL. Also in this aspect, the air vent is configured to “burp” the flexiliner and release excess gas or fill the flexiliner with nitrogen or the like. Moreover, the valve further includes a cam lever being configured to open and close the valve to move the cargo therethrough. Also, the cargo in this aspect is a fluid and the valve further includes an anti-vortex device disposed in the flexiliner proximate the interior surface, the anti-vortex device being configured to prevent formation of a gyrating vortex in the fluid disposed in the flexiliner and to permit a more thorough discharge.

A carton for packaging the flexiliner in this aspect of the invention is configured to be unfolded and defines a cut-out therein, the cut-out being complementary in size to the manhole, the carton being further configured to protect the flexiliner from damage during installation through the cut-out into the manhole.

In yet another aspect of the invention, a payload system for a cargo carrier includes a spillbox having a collar, a tube and a valve, the collar being configured to seat about a manhole of a shipping container, the tube defining a first end and a second end, the first end being connectable to a flexiliner disposed in the shipping container, the second end being connectable to the valve for communicating a load of cargo through the manhole, the spillbox being further configured for unseating from about the manhole to remove the flexiliner through the manhole when the load of cargo is extracted from the flexiliner.

In this aspect, the manhole includes an access port and a manhole lid, the access port being configured for human entry, the manhole lid being configured for opening and closing the access port. Also, the access port includes a plurality of latches disposed thereabout and the manhole lid defines a plurality of catches disposed thereabout, each of the latches being configured to connect to respective ones of the catches to lock the spillbox under the manhole lid. Furthermore, a plurality of tie-downs to secure the spillbox within the access port are provided in this aspect.

Also in this aspect, the collar defines a recess therein and the valve includes an orifice end and a cap, the orifice end defining an orifice therethrough, the cap being configured to access the orifice, the cap when attached to the orifice end disposed in the recess under the manhole lid.

The valve in this aspect further includes a tube end, an orifice end and a lever, the tube connected to the tube end of the valve, the orifice end connectable to a supply hose and the lever being configured to open and close communication between the orifice end and the tube end to move the load of cargo from the supply hose through the orifice end and the tube end into the flexiliner. The collar can also defines a perimeter and a lip disposed about the perimeter and the manhole defines a complementary lip for seating the lip of the collar.

Other aspects and advantages of the invention will be apparent from the following description and the attached drawings, or can be learned through practice of the invention.

### BRIEF DESCRIPTION OF THE DRAWINGS

Further aspects and advantages of the invention will be apparent from the following description, or can be learned through practice of the invention, in combination with the drawings in which:

FIG. 1 is a perspective view of a spillbox system shown in an intended use environment in accordance with an aspect of the invention;

FIG. 2 is a perspective view of a spillbox of the spillbox system as in FIG. 1;

FIG. 3 is a fragmentary, perspective view of a method of installing a liner of the spillbox system as in FIG. 1 in an interior of a cargo container in accordance with another aspect of the invention;

FIG. 4 is a top perspective view of a conduit of the liner as in FIG. 3;

FIG. 5 is a fragmentary, perspective view of the interior of the cargo container, particularly showing a hose of the spillbox system attached to the conduit as in FIG. 4;

FIG. 6 is a partial detailed view of the hose attached to the conduit as in FIG. 5;

FIG. 7 shows a step in a method of installing the spillbox system in a manhole of the cargo container as in FIG. 1;

FIG. 8 is a top perspective view of the spillbox after installation about the manhole as in FIG. 7;

FIG. 9 is a top perspective view of a hatch secured over the manhole and the spillbox as in FIG. 8;

FIG. 10 is a partial cross-sectional view of the manhole lid and the spillbox taken along line 10-10 in FIG. 9;

FIGS. 11A and 11B are perspective views showing steps in a method of using a spillbox kit in accordance with another aspect of the invention; and

FIG. 12 is a top perspective view of another embodiment of a liner with a valve assembly and an air vent in accordance with a further aspect of the invention.

### DETAILED DESCRIPTION OF THE INVENTION

Detailed reference will now be made to the drawings in which examples embodying the present invention are shown. The detailed description uses numerical and letter designations to refer to features of the drawings. Like or similar designations of the drawings and description have been used to refer to like or similar parts of the invention.

The drawings and detailed description provide a full and written description of the invention, and of the manner and process of making and using it, so as to enable one skilled in the pertinent art to make and use it, as well as the best mode of carrying out the invention. However, the examples set forth in the drawings and detailed description are provided by way of explanation only and are not meant as limitations of the invention. The present invention thus includes any modifications and variations of the following examples as come within the scope of the appended claims and their equivalents.

The figures generally show drop-in, pull-out spillbox systems including flexible liners used for loading and unloading a cargo container with a first liquid or other cargo through a manhole in the cargo container. The first liquid is unloaded from the liner at a destination, and the liner is removed and replaced with another liner for loading a second liquid or another cargo for shipment to another destination without having to clean the cargo container.

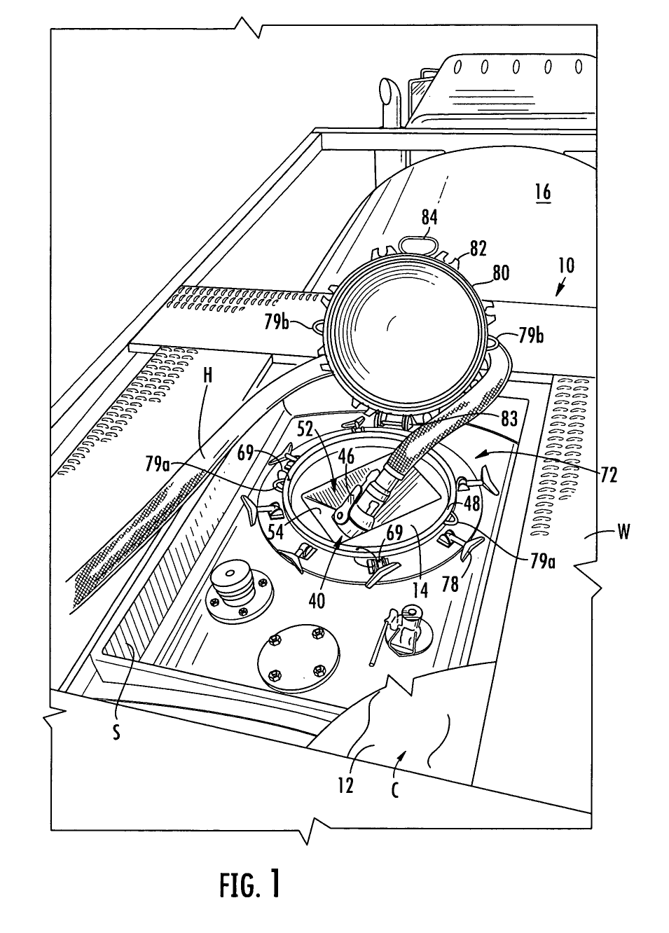

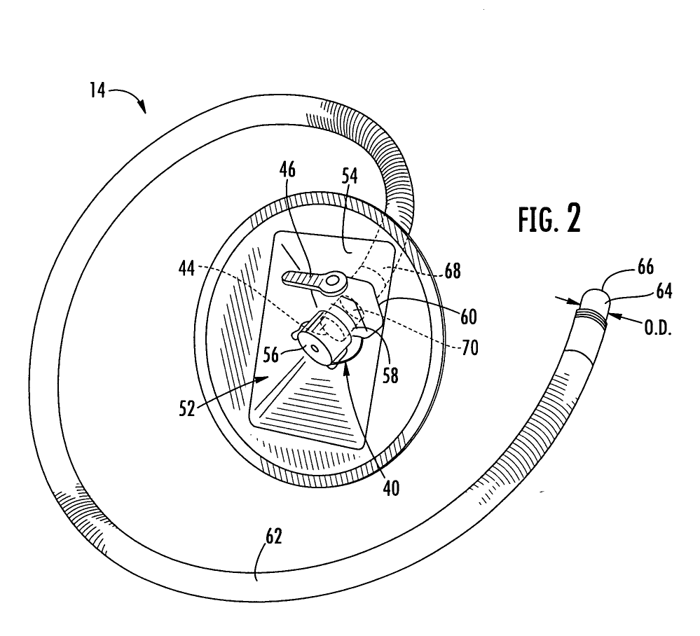

With reference to FIGS. 1 and 2, a spillbox system is designated in general by the number 10. As shown, the spillbox system 10 is installed in a shipping container 16, which in this example includes a walkway W for loading or unloading cargo C via the spillbox 14. The cargo C can be industrial fluids, liquids such as chemicals or beverages, or consumable food products.

As shown in FIGS. 1 and 2, the spillbox system 10 broadly includes a liner 12 and a spillbox 14. As partially shown in FIG. 1, the liner 12 is alternatively referred to herein as an “inner liner”, a bag, a bladder, a “flexitank” or a “monoliner” and is described in greater detail below. One skilled in the art will instantly recognize that the shipping container 16 and thus the liner 12 can be box-shaped, rectangle-shaped, cylindrically shaped or shaped otherwise to meet a variety of shipping requirements. Thus, the spillbox system 10 can be used with any container for ships, tractor-trailers, trains or the like and is not limited to the shipping container 16 shown in this example.

FIGS. 1 and 2 further show the spillbox 14 installed at a manhole 72 surrounded by a spill wall S on the shipping container 16. As shown in these figures, the spillbox 14 includes a valve 40 seated in a recess 52, a collar or skirt 48 formed around the recess 52, and a tube or hose 62 for connection to the liner 12. In this example, the spillbox 14 is made of aluminum, but the skilled artisan will instantly recognize that the spillbox 14 can be made of other metals, plastics or other durable material and is not limited to aluminum.

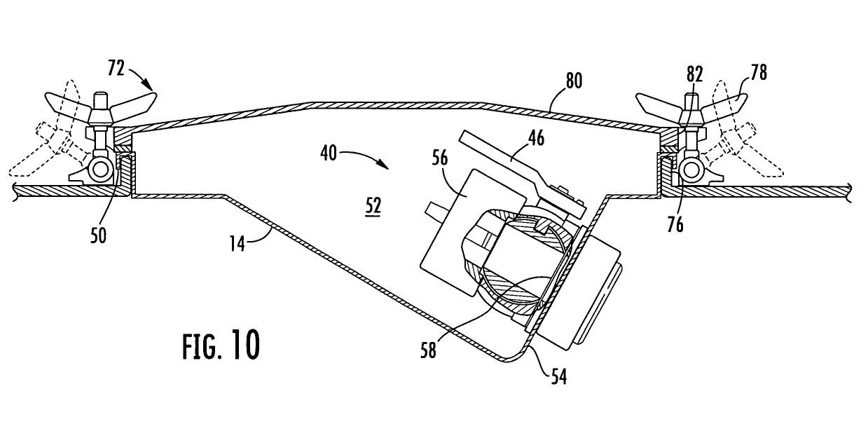

As further shown in FIGS. 1 and 2, the collar 48 defines a perimeter, which is sized to fit over the manhole 72. With the collar 48 seated around the manhole 72 and the valve 40 attached to a support wall 54 of in the recess 52, the valve 40 is recessed at an appropriate angle and depth to secure a manhole lid or hatch 80 of the shipping container 16 about the spillbox 14. More particularly and with brief reference to FIG. 10, the support wall 54 is angled to minimize its intrusion into the container 16 to minimize contact with the liner 12 when the liner 12 is filled with the cargo C.

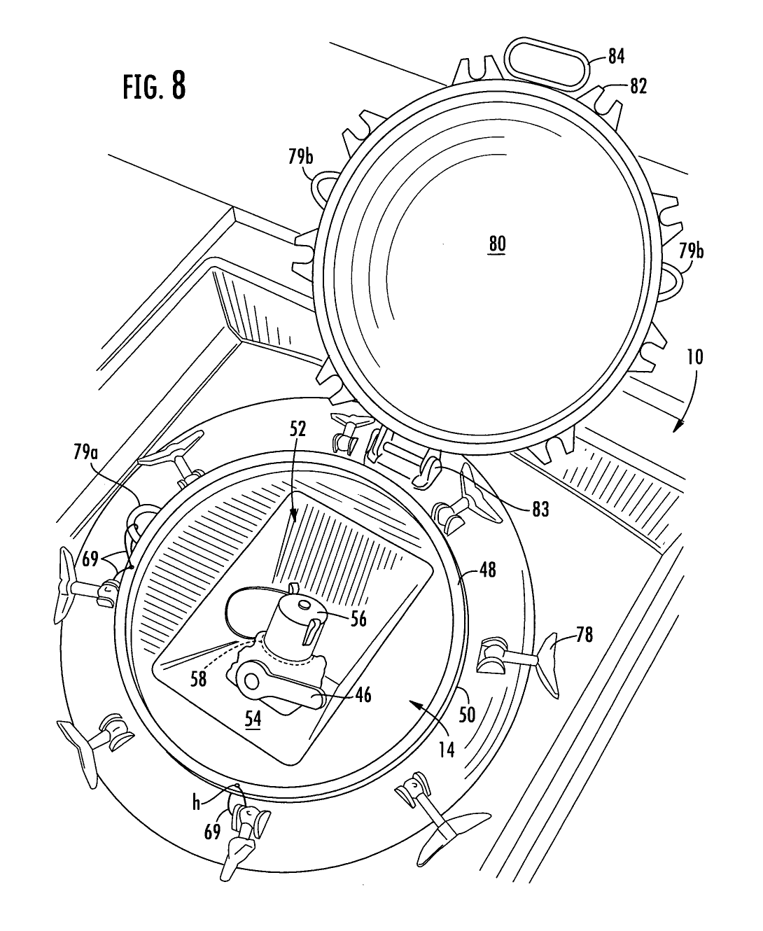

Continuing with reference to FIG. 1, a hinge assembly 83 and a handle 84 are used to close the hatch 80 over the spillbox 14 and the valve 40. A plurality of latches 78 is installed around the manhole 72 and secured to a plurality of corresponding lugs 82 on the hatch 80. One or more loops 79A can be attached around the manhole 72, and one or more complementary loops 79B can be attached to the hatch 80. Thus, one or more plastic tie-downs or cable ties 69 can be used to further secure the spillbox 14 to respective loops 79A or to the latches 78 via a plurality of holes “h” formed in the spillbox 14 such as in the collar 48 (see also FIG. 8).

The valve 40 shown in FIGS. 1 and 2 also includes an opening or orifice 44 (shown in phantom in FIG. 2), a cap 56, an orifice end 58 and a tube end 60. The cap 56 snaps on or screws around the orifice end 58 in a known manner to protect the orifice end 58 from damage by foreign objects and to prevent debris from entering the orifice 44 when the valve 40 is not in use. When the cap 56 is removed from the orifice end 58 as in FIG. 1, a pumping or discharge hose H is attached to the orifice end 58 by press-fitting, screwing or locking the hose H to the orifice end 58 in a known manner. As shown, a valve lever 46 is moved to an open position on the valve 40 to pump the cargo C into the liner 12 within the shipping container 16. As shown for example in FIG. 10A, the valve 40 can be a ball-type valve arrangement, which is activated by rotating the lever 46 to open the orifice 44. Those skilled in the art will instantly recognize that other types of valves such as butterfly valves, gate valves, flap valves and the like, as well as combinations of these and other types of valves, can be used for the valve 40.

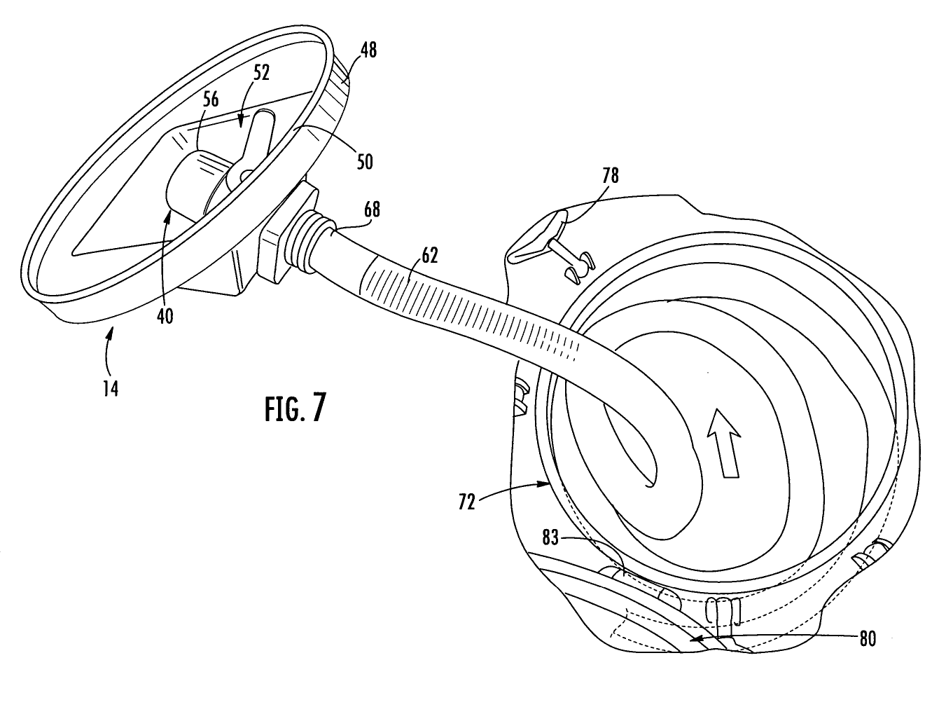

With more particular reference to FIG. 2, the tube 62 of the spillbox 14 is shown most clearly. The tube 62 in this example is a flexible, ribbed polymer tube, which includes a first end 64 defining a first opening 66 and a second end 68 defining a second opening 70. As discussed further with respect to FIG. 7 below, the polymer tube 62 can have a spring constant or memory from being in a rolled arrangement, which tends to urge the tube 62 into a coiled arrangement for storage and shipping. The tube 62 can also include an embedded spring (not shown) to impart an additional spring constant to the tube 62.

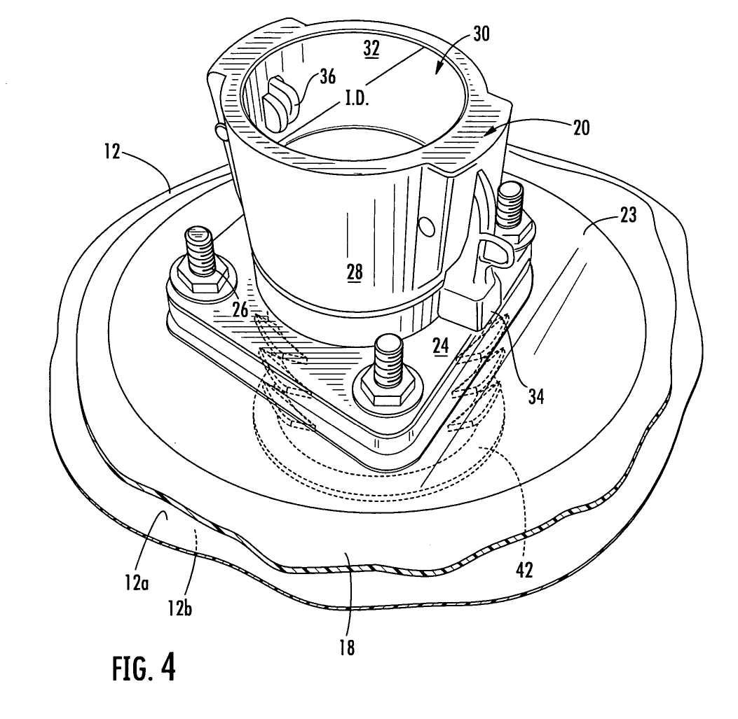

FIG. 2 further shows that the second end 68 of the tube 62 is connected to the tube end 60 of the valve 40. The first end 64 of the tube 62 is for connection to a sleeve 28 of the conduit 20 as discussed in detail with respect to FIG. 4 below. As FIG. 2 further shows, the first end 64 has an outer diameter O.D., which is smaller than an inner diameter I.D. defined by an inner surface 32 of the sleeve 28 in FIG. 4. The outer diameter O.D. is snap-fitted or screwed into the inner diameter I.D. as will be described by example operation below.

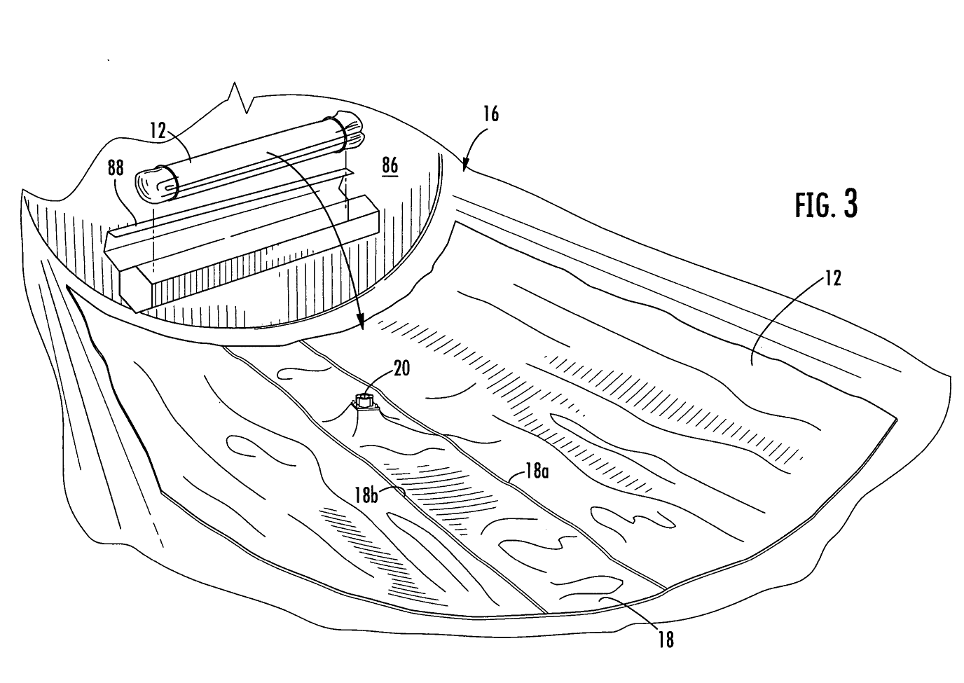

FIG. 3 most clearly shows the liner 12, briefly introduced above. The skilled artisan will recognize that the liner 12 is not shown to scale relative to an interior 86 of the container 16 for sake of discussion. In this example, the liner 12 is made from a disposable, recyclable, thermoplastic such as polyethylene. To decrease weight and thus reduce manufacturing costs and recurring shipping costs, the liner 12 can be a single layer or multiple layers of thermoplastic having an overall thickness of about 20 MIL (about 0.5 mm) to about 60 MIL. Since the liner 12 can be used for shipping cargo C in the form of beverages for human consumption, the thermoplastic chosen for the liner 12 can be FDA, EU and Kosher certified. Those skilled in the art will recognize that polyethylene is only one thermoplastic material that can be used for the liner 12. Many other polymers, elastomeric materials and the like, which are durable, extensible, resilient and flexible, can be used for the liner 12. For instance, an elastomeric material coated on its interior with an extensible, sealing film can be used for the liner 12; thus, the liner 12 is not limited to only polyethylene as described in the foregoing example.

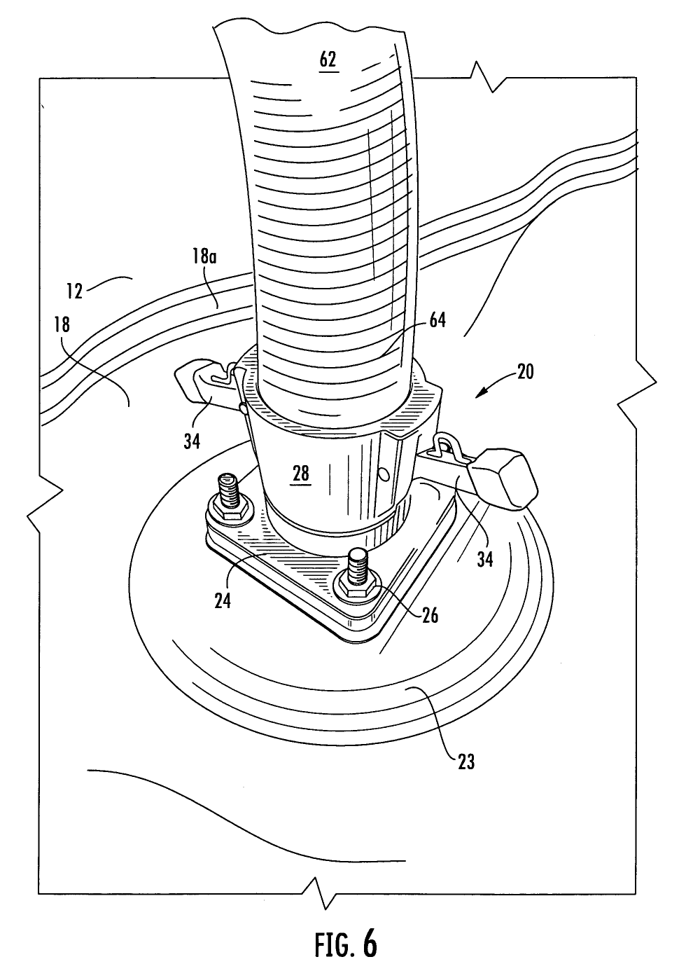

FIG. 3 further shows a make-up or reinforcement panel 18 that strengthens a section of the liner 12. The panel 18 can be a separate piece of thermoplastic material attached to the liner 12 at seams 18A, 18B, or the panel 18 can be formed by overlapping two ends of the liner 12 and sewing or gluing the two ends together to form the seams 18A, 18B. Since a majority of the liner 12 has a thickness of about 20 MIL to about 60 MIL as noted above, the reinforcement panel 18 serves to strengthen that portion of the liner 12 to which the conduit 20 is attached (see also FIG. 6) to withstand various stresses, which are discussed below. In the example shown in FIG. 3, the reinforcement panel 18 is approximately double the thickness of the liner 12; thus, the reinforcement panel 18 can have a thickness of about 40 MIL to about 80 MIL.

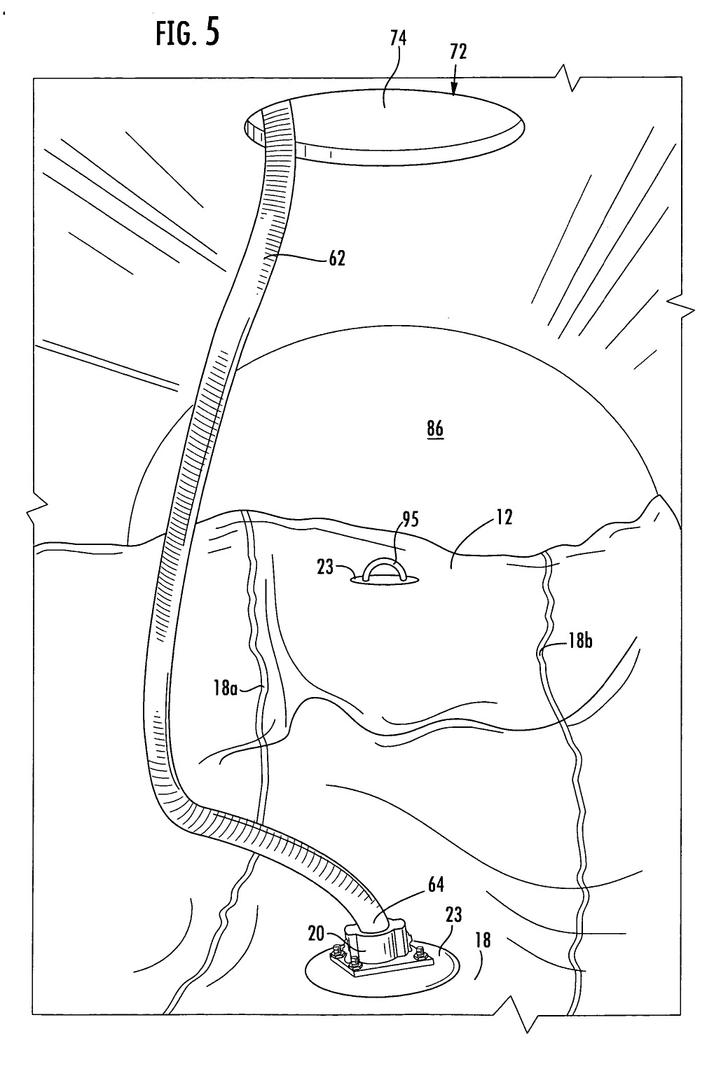

Also shown in FIG. 3, a carton or box 88 is provided in this embodiment to protect the liner 12 from abrasions, punctures or other damage, which can be caused by inadvertently dragging the liner 12 along the walkway W, or by snagging the liner 12 on equipment such as the coupling devices 78 introduced above. As shown, the liner 12 is folded or compacted initially in the box 88, and the box 88 and the liner 12 are dropped as a kit through the manhole 72 into an interior 86 of the shipping container 16. After the box 88 is in the interior 86, a technician (not shown) enters the manhole 72 (see, e.g., FIG. 5), opens the box 88, removes the liner 12 and unfolds the liner 12 as indicated by the large arrow in FIG. 3. Also shown, the technician positions the conduit 20 approximately under the manhole 72 and then egresses from the shipping container 16 with the box 88. If the shipping container 16 is angled on the truck, trailer or the like, the conduit 20 can be placed as required to leverage the angle and assist with unloading the cargo C.

Turning now to FIG. 4, the conduit 20 of the liner 12 is shown most clearly attached to the reinforcement panel 18 as mentioned above. As shown, the conduit 20 is attached by its sealing flange 24 via a plurality of nuts and bolts 26 to the reinforcement panel 18, which is attached to a first, outer or exterior surface 12A of the liner 12. The skilled artisan will instantly recognize that the sealing flange 24 can be attached to the reinforcement panel 18 in a variety of ways including adhesives, heat welding, or adhesives in combination with the exemplary nuts and bolts 26. For example, the sealing flange 25 can have an attachment base or ring 23 as shown to form a liquid-tight seal with the reinforcement panel 18. The ring 23 can be rubber, polyethylene or the like and can be heat-sealed, impulse welded or the like to the reinforcement panel 18. The ring 23 can also be about 80 MIL to about 120 MIL thick to withstand pulling, pushing and shear forces imparted by movements of the conduit 20. Accordingly, as the liner 12 is subjected to load shifts and shear forces during shipment of the cargo C, the reinforcement panel 18 and the attachment ring 23 strengthen that area of the liner 12 around the sealing flange 24 to prevent tears or ruptures in the liner 12.

FIG. 4 also more particularly shows the sleeve 28 of the conduit 20 as briefly introduced above. As shown, the sleeve 28 has an aperture 30 and an inner surface 32 defining the inner diameter I.D. for receiving the outer diameter O.D. of the first end 64 of the tube 62 as noted above. A plurality of quick-disconnect levers 34 in FIG. 4 is rotatably attached to the sleeve 28. The levers 34 can be locking cam levers that control respective cams 36, which project through the inner surface 32 of the sleeve 28. With brief reference to FIGS. 4, 5 and 6, the levers 34 rotate the cams 36 against or into a portion of the first end 64 of the tube 62 to hold the tube 62 within the sleeve 28.

FIG. 4 further shows an anti-vortex device 42, which is attached to a second, inner or interior surface 12B of the liner 12 in communication with the valve 40 to prevent generation of vortices as the cargo C is being unloaded or suctioned from the liner 12. As known, the anti-vortex device 42 can prevent a suction force from suctioning up the liner 12 itself. By way of example but not of limitation, Snyder et al. describes an exemplary anti-vortex device in U.S. Pat. No. 4,394,966.

As further shown in FIGS. 4, 5 and 6, the first end 64 of the hose 62 is attached to the sleeve 28 as described above. As shown, the tube 62 extends outward through an access hole 74 of the manhole 72. As noted above, the levers 34 in FIG. 4 are shown in an engaged position (the tube 62 is not shown for clarity and discussion purposes). In comparison to FIG. 4, the levers 34 are shown in FIG. 6 in an upright or disengaged position during insertion of the first end 64 of the tube 62. FIG. 5 also shows a lift ring 95 attached to the liner 12 via another attachment ring 23 as described above. The lift ring 95 can be tied to the spillbox 14 to assist in removing the empty liner 12 from the interior 86, or a worker can use a grappling hook (not shown) to hook the lift ring 95 and remove the empty liner 12.

With particular reference to FIGS. 5 and 7, the liner 12 is shown partially filled with the cargo C. As shown, the second end 68 of the tube 62 is connected to the valve 40 in the manner described above. As the liner 12 is being filled, the spring constant of the tube 62 causes the tube 62 to coil upward in a direction of the manhole 72 as indicated by the large arrow in FIG. 7. Also shown in FIG. 7, the collar 48 of the spillbox 14 is being positioned for placement about the manhole 72.

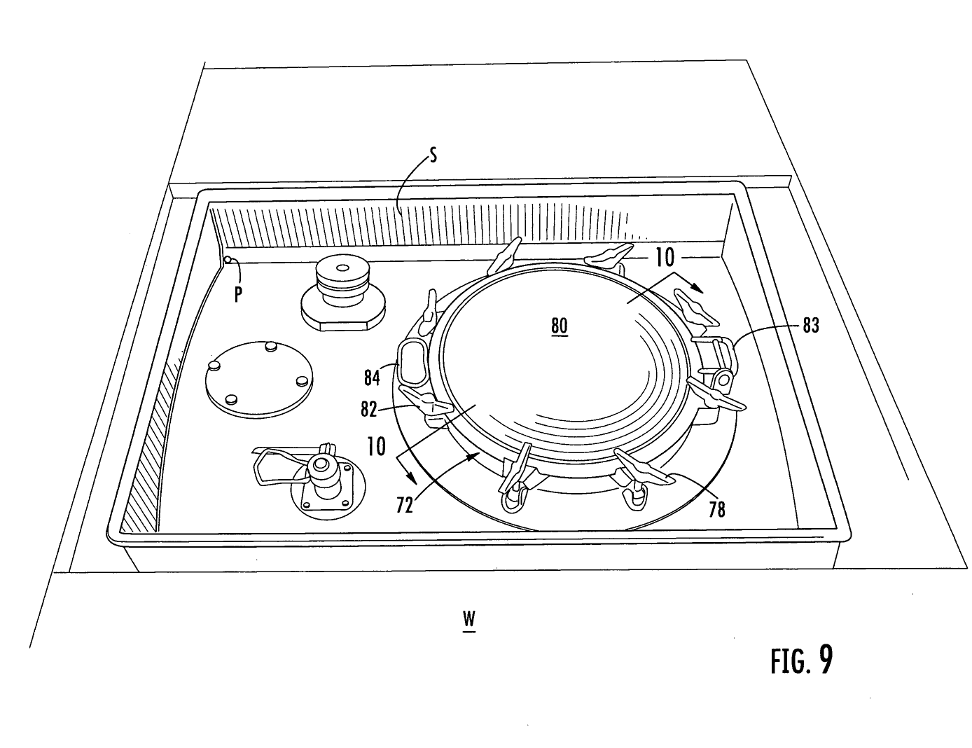

With reference now to FIGS. 8, 9 and 10, the spillbox 14 is seated about the manhole 72 of the container 16. As shown, a lip 50 defined on the collar 48 of the spillbox 14 overhangs a projection 76 of the manhole 72 to hold the spillbox 14 in place about the manhole 72. Also particularly shown in FIG. 8, a plurality of tie-downs 69, as introduced with respect to FIG. 1 above, can be attached to the collar 48 and to the loops 79A and/or the coupling devices 78 to further secure the spillbox 14 in the manhole 72 for shipment. Additionally, in this example, the spillbox 14 is made of aluminum and its inherent weight forces the lip 50 downward on the projection 76 to further secure the spillbox 14 in position. Moreover, the lip 50 serves to direct any liquid overflow (not shown) out of the spillbox 14 in a direction of the spill walls S of the container 16, and more particularly, through a port P as shown in FIG. 9 to prevent the liquid overflow from entering the interior 86 of the container 16.

With more particular reference to FIGS. 9 and 10, the hatch 80 is shown closed over the spillbox 14. As shown in FIG. 9, the coupling devices 78 are screwed onto or latched down on the lugs 82 from their open positions shown in phantom in FIG. 10. Those skilled in the art will recognize that the coupling devices 78 can be wing nuts, snaps, latches, lugs, or clamps and the lugs 82 can be a variety of receptacles for receiving and attaching to the coupling devices 78. Further, the coupling devices 78 and the lugs 82 can be interchanged as known to those skilled in the art. As shown in FIG. 10, the valve 40 is attached to the support wall 54 at an angle to facilitate closure of the hatch 80 with minimal intrusion into the interior 86 of the shipping container 16 and ultimately to attach a take-away hose H.

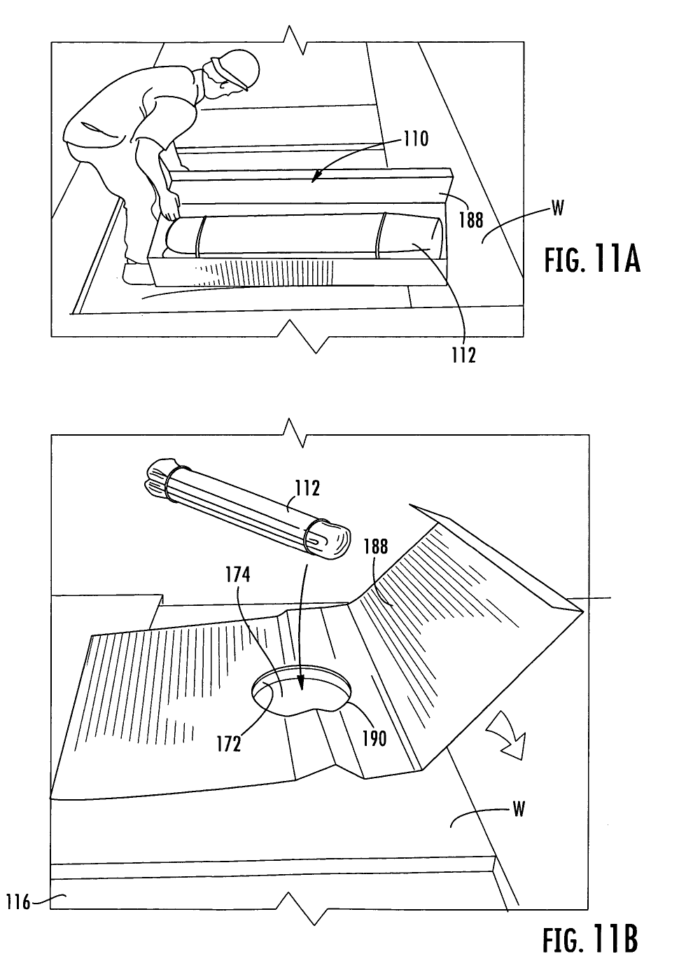

Turning now to FIGS. 11A and 11B, a kit 110 is shown including a liner 112 in a carton 188. A spillbox (not shown) similar to the spillbox 14 can be shipped as a kit with the carton 188 in one aspect of the invention. Some components of this embodiment and their dimensions and material are similar to the previously described embodiments and reference is made to the foregoing embodiments for a full and enabling disclosure of the present embodiment.

More specifically, as shown in FIGS. 11A and 11B, the liner 112 is removed from the carton 188. For discussion purposes only, the liner 112 and the carton 188 are not shown to scale in these figures. As shown, the carton 188 is unfolded to reveal a precut hole or cutout 190, which is sized to fit about a manhole 172 of a shipping container 116. In this example, the carton 188 is cardboard or other material sufficiently durable for at least a single use to protect the liner 112 from rough surfaces such as those found on the walkway W. As shown, once the cutout 190 is aligned with an access hole 174 of the manhole 172, the liner 112 is dropped through the access hole 174 and the cutout 190 for installation in the shipping container 116 in a manner substantially as described above with respect to FIG. 3.

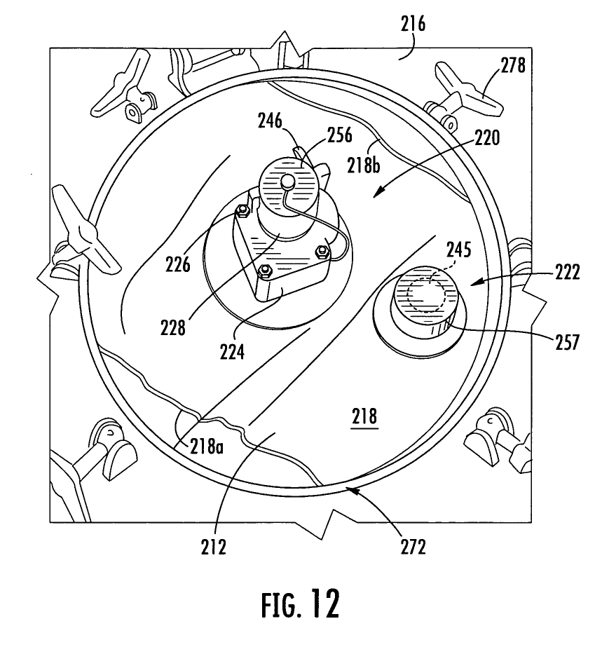

Turning now to FIG. 12, a liner 212 in accordance with another embodiment of the invention generally includes a valve assembly 220 and an air vent 222. Similar to the previous embodiments, the liner 212 is inserted in a container 216, and after loading, excess air can be removed from the liner 212 via the air vent 222. As shown, the valve assembly 220 includes a sleeve 228 and a cap 256 to protect the sleeve 228. Also shown, the valve assembly 220 is attached to a reinforcement panel 218 via a flange 224 and a plurality of bolts and nuts 226 and/or other attachment devices. As in the previous embodiments, the reinforcement panel 218 shown in FIG. 12 strengthens an area about the flange 224 such that shear and other load forces during loading, shipment and unloading of the cargo do not rupture the liner 212.

FIG. 12 further shows a valve lever 246 for operating the valve assembly 220 in substantially the manner described above with respect to the spillbox valve 40. Thus, the cap 256 is unscrewed or pried upward to attach a take-away hose similar to the hose H in FIG. 1. The lever 246 is rotated or switched to an open position and the cargo is loaded into or unloaded from the liner 212 via the hose.

One aspect of the invention may be better understood with reference to a method as shown in FIGS. 1-9. As shown and briefly described above, the liner 12 can be shipped in the box 88 and the spillbox 14 can be shipped in another box (not shown) palletized as a kit. At the shipping container 16, the box 88 with the liner 12 is dropped through the access hole 74 of the manhole 72 of the shipping container 16. A technician extracts the liner 12 from the box 88, unrolls or unwraps the liner 12 and can position its conduit 20 under the access hole 74 or where desired. The spillbox 14 is positioned near the manhole 72 and the hose 62 is inserted through the access hole 74 for the technician to connect the hose 62 to the conduit 20. The technician egresses with the box 88 from the container 16 through the access hole 74 of the manhole 72 and discards or recycles the box 88.

More particularly, as shown in FIGS. 4, 5 and 6, for instance, the first end 64 of the tube 62 is press-fitted into the sleeve 28 and the levers 34 are pressed downward to rotate the cams 36 into or against the first end 64 of the tube 62 to hold the first end 64 within the sleeve 28.

As shown in FIGS. 7 and 8, the spillbox collar 48 is placed over the projection 76 of the manhole 72. The cap 56 is removed from the orifice end 58 of the valve 40, and the hose H as shown in FIG. 1 is attached to the orifice end 58. The valve lever 46 is rotated to an open position as shown in FIG. 1 and the cargo C is loaded into the liner 12. As shown in FIG. 7, as the liner 12 is filled with cargo, the liner 12 raises the tube 62 in a direction of the manhole 72. Once the cargo C is loaded, excess air can be emptied from the liner 12. Finally, the hatch 80 is closed as shown in FIGS. 9 and 10 with the valve 40 secured beneath but not obstructing the hatch 80.

The foregoing steps also apply substantially to the alternative embodiments described above such as with the liner 212. For instance, the hatch 280 is closed about the valve assembly 220.

At destination, the liner 12, 112, 212 can be emptied via the hose H through the manhole 72, 172, 272 without having to unload the cargo C through any other aperture of the shipping container 16, 116, 216. Moreover, a vacuum source can be connected to the valve 40 or valve assembly 220 after the cargo C has been emptied from the liners 12, 212 to suction the liner 12, 212 from within the shipping container 16, 216. Alternatively, a lifting device such as the lift ring 95 shown in FIG. 5 can be installed on the liner 212 to remove the used liner from the shipping container 216. Thus, the liner 212 can be quickly and easily disposed of and the shipping container can be used in a conventional fashion without another liner 212, or a new liner 212 can be installed to reuse the shipping container for shipping a different cargo from the same point without having to clean the shipping container and without having to send the shipping container to a distant cleaning station for cleaning before it can enter shipping lanes again.

While preferred embodiments of the invention have been shown and described, those skilled in the art will recognize that other changes and modifications may be made to the foregoing examples without departing from the scope and spirit of the invention. For instance, various durable, recyclable materials can be used for the liners described herein. It is intended to claim all such changes and modifications as fall within the scope of the appended claims and their equivalents.

1. A method of using a payload system with a cargo carrier, the method comprising the steps of:
providing a flexiliner with a conduit attached thereto;
installing the flexiliner through a manhole of a shipping container;
providing a spillbox having a collar, a tube and a valve, the tube defining a first end and a second end;
connecting the first end to the conduit, the second end being connected to the valve; and
seating the collar about the manhole for communicating a load of cargo therethrough to prevent contamination of the cargo.

2. The method of using the payload system as in claim 1, wherein the flexiliner is made of an elastomeric material or a thermoplastic material.

3. The method of using the payload system as in claim 2, further comprising the step of making the flexiliner with a thickness of about 20 MIL to about 60 MIL.

4. The method of using the payload system as in claim 2, further comprising the step of making the flexiliner with a reinforcement section having a thickness of about 40 MIL to about 80 MIL, the conduit being attached to the reinforcement section.

5. The method of using the payload system as in claim 1, wherein the conduit includes a flange with a sleeve depending therefrom, the flange attached to the exterior surface, the sleeve having an inner surface defining an inner diameter and having a disconnect assembly, the first end having an outer diameter smaller than the inner diameter, and further comprising the steps of inserting the first end in the inner diameter and engaging the first end with the disconnect assembly.

6. The method of using the payload system as in claim 1, wherein the manhole defines an access port having a plurality of latches disposed thereabout and a manhole lid having a plurality of catches disposed thereabout, and further comprising the step of connecting each of the latches to respective ones of the catches to lock the spillbox under the manhole lid.

7. The method of using the payload system as in claim 6, further comprising the step of securing the spillbox within the access port using a plurality of tie-downs.

8. The method of using the payload system as in claim 1, wherein the valve defines a tube end, an orifice end and a lever, the tube connected to the tube end of the valve, and further comprising the steps of attaching a supply hose to the orifice end and activating the lever to open or close communication between the orifice end and the tube end to move the load of cargo from the supply hose through the orifice and tube ends into the flexiliner.

9. The method of using the payload system as in claim 1, further comprising the step of seating a lip disposed about a perimeter of the collar on a complementary lip defined about the manhole.

10. The method of using the payload system as in claim 1, further comprising the step of closing a liner valve attached to the conduit, the liner valve being configured to close the flexiliner during removal of the flexiliner from the manhole to prevent a residue of the cargo from spilling from the flexiliner.

11. The method of using the payload system as in claim 1, further comprising the step of providing a carton for packaging at least one of the flexiliner and the spillbox as a kit.

12. The method of using the payload system as in claim 11, further comprising the step of vacuum packing the flexiliner for installation in the carton.

13. The method of using the payload system as in claim 12, further comprising the steps of unfolding the carton, the carton defining a cut-out therein, the cut-out complementary in size to the manhole, and positioning the cut-out over the manhole to protect the flexiliner from damage during installation through the cut-out into the manhole.

14. The method of using the payload system as in claim 1, further comprising the step of unfolding the flexiliner in the shipping container.

15. The method of using the payload system as in claim 1, further comprising the step of snap-fitting the first end of the tube to the sleeve of the flexiliner in the shipping container.

16. The method of using the payload system as in claim 1, further comprising the step of locking the first end of the tube to the sleeve of the flexiliner in the shipping container using a quick disconnect lever.

17. The method of using the payload system as in claim 1, further comprising the step of unseating the spillbox from about the manhole after the load of cargo is extracted from the flexiliner.

18. The method of using the payload system as in claim 1, further comprising the step of removing the flexiliner through the manhole after the load of cargo is extracted from the flexiliner.

19. The method of using the payload system as in claim 18, further comprising the step of vacuuming the flexiliner to condense the flexiliner before extracting it through the manhole.

20. The method of using the payload system as in claim 18, further comprising the step of discarding the flexiliner after removing the flexiliner through the manhole.

21. A payload system for a cargo carrier, the payload system comprising:
a liner defining an exterior surface and an opposing interior surface and having a conduit attached to the exterior surface, the conduit defining an aperture therethrough in communication with the interior surface, the liner being configured for installation in a shipping container through a manhole of the shipping container; and
a spillbox including a collar, a tube and a valve, the collar being configured to seat about the manhole, the tube defining a first end and a second end, the first end being connectable to the conduit, the second end being connectable to the valve for communicating a load of cargo through the manhole, the spillbox being further configured for unseating from about the manhole and the liner being further configured for removal through the manhole when the load of cargo is extracted from the liner.

22. The payload system as in claim 21, wherein the liner is an elastomeric or thermoplastic liner.

23. The payload system as in claim 21, wherein the liner is made from a polyethylene material.

24. The payload system as in claim 21, wherein the liner has a thickness of about 20 MIL to about 60 MIL.

25. The payload system as in claim 21, wherein the liner has a thickness of about 20 MIL to about 60 MIL and includes a reinforcement section having a thickness of about 40 MIL to about 80 MIL, the conduit being attached to the reinforcement section.

26. The payload system as in claim 21, wherein the conduit includes a flange with a sleeve depending therefrom, the flange attached to the exterior surface, the sleeve having an inner surface defining an inner diameter and having a disconnect assembly, the first end having an outer diameter smaller than the inner diameter, the disconnect assembly being configured to engage the first end when the outer diameter is disposed in the inner diameter.

27. The payload system as in claim 21, wherein the manhole includes an access port and a manhole lid, the access port being configured for human entry, the manhole lid being configured for opening and closing the access port.

28. The payload system as in claim 27, wherein the access port includes a plurality of latches disposed thereabout and the manhole lid defines a plurality of catches disposed thereabout, each of the latches being configured to connect to respective ones of the catches to lock the spillbox under the manhole lid.

29. The payload system as in claim 28, further including a plurality of tie-downs to secure the spillbox within the access port.

30. The payload system as in claim 28, wherein the collar defines a recess therein and the valve includes an orifice end and a cap, the orifice end defining an orifice therethrough, the cap being configured to access the orifice, the cap when attached to the orifice end disposed in the recess under the manhole lid.

31. The payload system as in claim 30, wherein the valve further includes a tube end, an orifice end and a lever, the tube connected to the tube end of the valve, the orifice end connectable to a supply hose and the lever being configured to open and close communication between the orifice end and the tube end to move the load of cargo from the supply hose through the orifice end and the tube end into the liner.

32. The payload system as in claim 31, wherein the collar defines a perimeter and a lip disposed about the perimeter and the manhole defines a complementary lip for seating the lip of the collar.

33. The payload system as in claim 31, further comprising a liner valve attached to the conduit, the liner valve being configured for closure during removal of the liner from the manhole to prevent a residue of the cargo from spilling from the liner.

34. The payload system as in claim 31, further comprising a carton for shipping the liner and the spillbox as a kit.

35. The payload system as in claim 31, wherein the carton is configured to be unfolded and defines a cut-out therein, the cut-out being complementary in size to the manhole, the carton being further configured to protect the liner from damage during installation through the cut-out into the manhole.

36. A payload system for a cargo carrier, the payload system comprising:
a flexiliner defining an exterior surface and an opposing interior surface, the flexiliner having a reinforcement panel formed on a portion of the exterior surface, the flexiliner being configured for installation through a manhole of a shipping container;
a valve attached to the reinforcement panel, the valve defining an aperture therethrough in selectable communication with the interior surface; and
an air vent disposed proximate the valve, the air vent defining an opening therethrough in selectable communication with the interior surface, the air vent being configured to inflate the flexiliner to dispose the valve and the air vent at the manhole for loading or unloading cargo.

37. The payload system as in claim 36, wherein the flexiliner is made from a polyethylene material.

38. The payload system as in claim 36, wherein the flexiliner has a thickness of about 20 MIL to about 60 MIL.

39. The payload system as in claim 36, wherein the flexiliner is made from a see-through polycarbonate being configured to view the cargo therein.

40. The payload system as in claim 36, wherein the reinforcement section has a thickness of about 40 MIL to about 80 MIL.

41. The payload system as in claim 36, wherein the air vent is configured to release an excess amount of air from the flexiliner after loading the cargo.

42. The payload system as in claim 36, wherein the valve further includes a cam lever being configured to open and close the valve to move the cargo therethrough.

43. The payload system as in claim 36, wherein the cargo is a fluid and the valve further includes an anti-vortex device disposed in the flexiliner proximate the interior surface, the anti-vortex device being configured to permit discharge of the fluid disposed in the flexiliner.

44. The payload system as in claim 36, further comprising a carton for packaging the flexiliner, the carton being configured to be unfolded and defining a cut-out therein, the cut-out being complementary in size to the manhole, the carton being further configured to protect the flexiliner from damage during installation through the cut-out into the manhole.

45. The payload system as in claim 36, further comprising a carton for packaging the flexiliner, the carton being configured for insertion through the manhole, the carton being further configured to be opened in the cargo carrier to release the flexiliner therein, the carton being configured to protect the flexiliner from damage during insertion through the manhole.

46. The payload system as in claim 36, further comprising a tube and valve being configured for storage under a hatch.

47. A payload system for a cargo carrier, the payload system comprising:
a spillbox having a collar, a tube and a valve, the collar being configured to seat about a manhole of a shipping container, the tube defining a first end and a second end, the first end being connectable to a flexiliner disposed in the shipping container, the second end being connectable to the valve for communicating a load of cargo through the manhole, the spillbox being further configured for unseating from about the manhole to remove the flexiliner through the manhole when the load of cargo is extracted from the flexiliner.

48. The payload system as in claim 47, wherein the manhole includes an access port and a manhole lid, the access port being configured for human entry, the manhole lid being configured for opening and closing the access port.

49. The payload system as in claim 48, wherein the access port includes a plurality of latches disposed thereabout and the manhole lid defines a plurality of catches disposed thereabout, each of the latches being configured to connect to respective ones of the catches to lock the spillbox under the manhole lid.

50. The payload system as in claim 48, further including a plurality of tie-downs to secure the spillbox within the access port.

51. The payload system as in claim 47, wherein the collar defines a recess therein and the valve includes an orifice end and a cap, the orifice end defining an orifice therethrough, the cap being configured to access the orifice, the cap when attached to the orifice end disposed in the recess under the manhole lid.

52. The payload system as in claim 47, wherein the vale further includes a tube end, an orifice end and a lever, the tube connected to the tube end of the valve, the orifice end connectable to a supply hose and the lever being configured to open and close communication between the orifice end and the tube end to move the load of cargo from the supply hose through the orifice end and the tube end into the flexiliner.

53. The payload system as in claim 47, wherein the collar defines a perimeter and a lip disposed about the perimeter and the manhole defines a complementary lip for seating the lip of the collar.
